(19) United States
(12) Patent Application Publication
(10) Pub. No.: US 2004/0000096 A1
(43) Pub. Date: Jan. 1, 2004

(54) MAGNETIC WEATHERSTRIP

(76) Inventor: David Simon, Harrison Township, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/184,597

(22) Filed: Jun. 27, 2002

(51) Int. Cl. E06B 7/16

(52) U.S. Cl. 49/478.1

(57) ABSTRACT

A weatherproofing assembly for sealing cracks between a door and a frame associated with the door, and a method of using the weatherstrip assembly. The assembly provides a flexible magnetic strip for sealing the cracks. The strip magnetically attaches to one of the door and the frame such that an overhang portion extends therebeyond. When the door is in a closed position, the overhang portion lies overtop of the cracks. Additionally, the strip may magnetically attach to the other of the door and the frame, thereby better sealing the cracks.

### BACKGROUND OF THE INVENTION

The present invention relates to weatherproofing assemblies, and more particularly to a magnetic weatherproofing strip for sealing cracks between a door and an associated door frame.

Ideally, weatherproofing material is easy to install and inexpensive to manufacture. Most weatherproofing assemblies employ the use of adhesives or mechanical attachment means to attach a weatherproofing strip to a door. These assemblies generally contain many different interworking parts and therefore are expensive to manufacture and complicated to install. In addition, the need for adhesive or mechanical attachment means can permanently mar the surface of a door. If the door comprises a magnetic material, a magnetic attachment means could solve this problem. However, current magnetic weatherproofing systems have not eliminated the need for a plurality of parts or still require the use of adhesives in some manner.

Accordingly, it is desirable to provide a weatherproofing assembly that is inexpensive to manufacture and install and simple in construction which quickly and magnetically attaches to either a door or an associated door frame.

### SUMMARY OF THE INVENTION

The weatherproofing assembly according to the present invention provides a flexible magnetic strip for sealing cracks between a door and a frame associated with the door. The strip comprises magnetic sheeting and attaches to either the door or the frame so that an overhang portion of the strip extends beyond the door or the frame to which the strip is attached. When the door is in a closed position, the overhang portion lies overtop of the cracks.

The present invention is therefore inexpensive to manufacture and install and simple in construction due to the availability of the material. In addition, the strip quickly attaches to either a door or an associated frame magnetically, significantly reducing installation time and expense.

### BRIEF DESCRIPTION OF THE DRAWINGS

The various features and advantages of this invention will become apparent to those skilled in the art from the following detailed description of the currently preferred embodiments. The drawings that accompany the detailed description can be briefly described as follows:

FIG. 1 is a general perspective view of the present invention;

FIG. 2 is an overhead view of the invention in FIG. 1 with the door in the closed position, taken along line 2-2 of FIG. 1;

FIG. 3 is a perspective view of a first embodiment of the invention in FIG. 1 with the door in an open position;

FIG. 4 is an overhead view of the invention in FIG. 3, taken along line 2-2 of FIG. 1; and

FIG. 5 is an overhead view of a second embodiment of the present invention with the door in the open position, taken along line 2-2 of FIG. 1.

### DETAILED DESCRIPTION OF THE PREFERRED EMBODIMENT

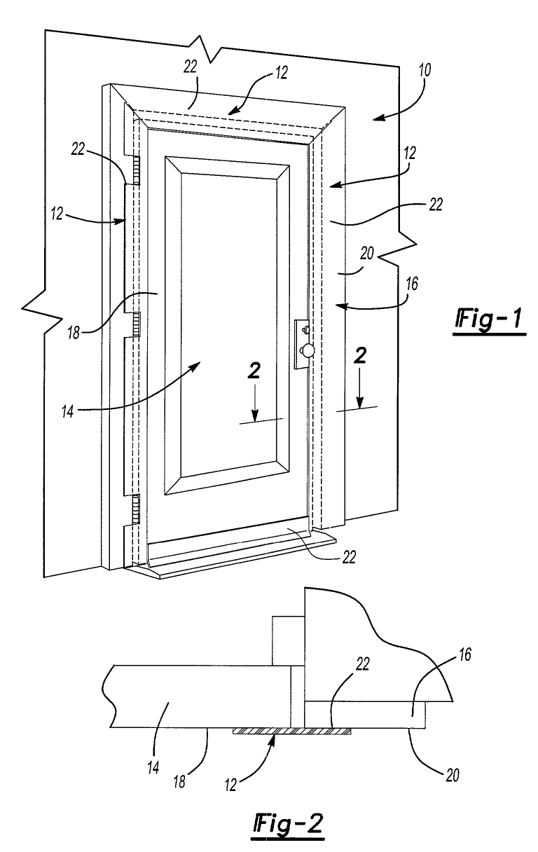

Referring to FIG. 1, the present invention is a weatherproofing assembly 10 including a magnetic strip 12 for sealing cracks (represented by hidden lines) between a door 14 and an associated frame 16. The strip 12 comprises flexible magnetic material such as 30 mil vinyl coated magnetic sheeting and magnetically attaches to either the door 14 or the frame 16, or to both the door 14 and the frame 16. The door 14 is defined as any means of entry into a building or a room and includes a first surface 18. The frame 16 may be a door frame surrounding the door 14, as in FIG. 1, an adjacent door as in a pair of double doors, or any other structure adjacent a door wherein cracks may develop between the structure and the door. The frame 16 includes a frame surface 20 relatively flush with the first surface 18 of the door 14.

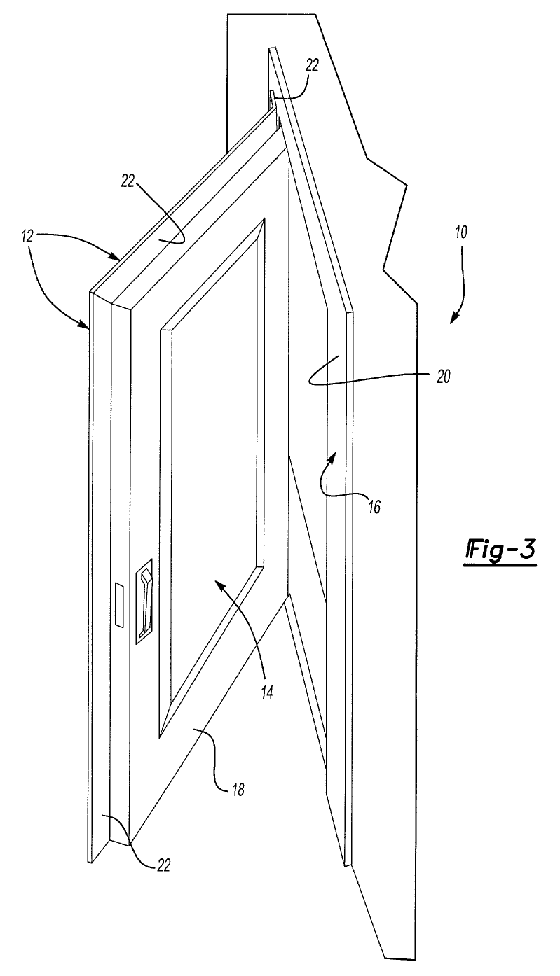

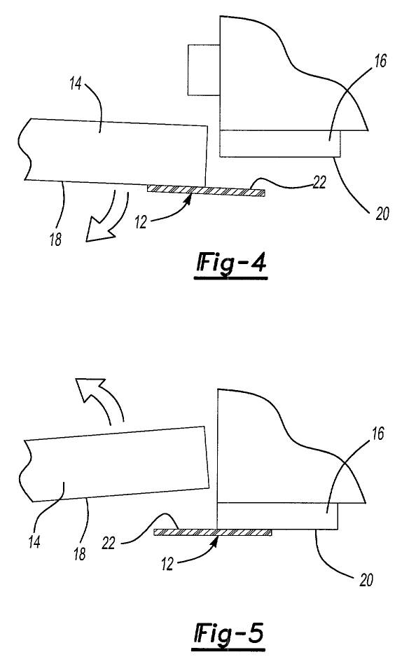

Referring next to FIG. 2, a first embodiment of the present invention is shown wherein the first surface 18 of the door 14 comprises a magnetic material while the frame surface 20 may or may not comprise a magnetic material. The strip 12 lays flat against and magnetically adheres to the first surface 18 leaving an overhang portion 22 extending beyond the door 14. When the door 14 is in a closed position as in FIG. 2, the overhang portion 22 lies against the frame surface 20 for sealing the cracks. FIG. 3 shows the door 14 moving from the closed position to an open position such that the strip 12 does not interfere with the frame 16. As the door 14 opens, the strip 12 remains attached to the door 14 and moves away from the frame 16 (FIG. 4). Closing the door 14 allows the strip 12 to again cover the cracks between the door 14 and the frame 16.

When the frame surface 20 also comprises a magnetic material, the strip 12 magnetically adheres to both the door 14 and the frame 16 when in the closed position for better sealing the cracks. The strip 12 must be placed so the overhang portion 22 adheres more strongly to the frame surface 20 than it does to the first surface 18; otherwise as the door 14 opens, the strip 12 will remain attached to the frame 16, causing the door 14 to contact the strip 12 as it returns to the closed position. If the magnetic properties of the first surface 18 are equal to the magnetic properties of the frame surface 20, this can be achieved by ensuring that the width of the portion of the strip 12 attached to the door 14 is greater than the width of the overhang portion 22. This may also be achieved by ensuring that the first surface 18 has a higher magnetic strength than the frame surface 20 and adjusting the widths of the attached and overhang portions of the strip 12 accordingly.

In a second embodiment of the present invention, the frame surface 20 comprises a magnetic material while the inner surface 18 of the door 14 may or may not comprise a magnetic material. The strip 12 lays flat against and magnetically adheres to the frame surface 20 leaving the overhang portion 22 extending beyond the frame 16. When the door 14 is in the closed position, the overhang portion 22 lies against the door 14 for sealing the cracks. Opening the door 14 (FIG. 5) moves the door 14 away from both the frame 16 and the attached strip 12. Closing the door 14 allows the strip 12 to again cover the cracks between the door 14 and the frame 16. When the first surface 18 of the door 14 also comprises a magnetic material, the strip 12 magnetically adheres to both the frame 16 and the door 14 when in the closed position for better sealing the cracks. In this embodiment, as with the first embodiment, it is important to place the strip 12 so the overhang portion 22 adheres more strongly to the frame 16 than to the door 14.

In each of the preferred embodiments described above, either the door 14 or the frame 16 is magnetic such that the magnetic strip 12 magnetically adheres to either the door 14 or the frame 16 or both. It should be appreciated, however, that the strip 12 may attach to either the door 14 or the frame 16 using adhesive. If the strip 12 is adhesively attached, neither the door 14 nor the frame 16 need be magnetic.

In each embodiment, the strip 12 may be cut to any length and width to fit the specific dimensions of the door 14 as needed. In addition, the flexibility of the strip 12 allows the present invention to be utilized along any edge of the door 14. For instance, manufacturing the strip 12 out of a more flexible material would allow effective use of the invention on a hinged edge or threshold of a door 14, as best shown in FIG. 1.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A weatherproofing assembly for sealing cracks between a door and an associated frame, said assembly comprising:
a door;
a frame associated with said door; and
a flexible magnetic strip magnetically attached to at least one of said door and said frame such that an overhang portion of said strip extends beyond said at least one of said door and said frame.

2. The assembly as recited in claim 1 wherein said door includes a first surface comprising a magnetic material such that said strip magnetically adheres to said first surface and said overhang portion extends beyond said door.

3. The assembly as recited in claim 2 wherein said frame includes a frame surface relatively flush with said first surface such that said overhang portion lies against said frame surface for sealing cracks between said door and said frame.

4. The assembly as recited in claim 2 wherein said frame includes a frame surface comprising a magnetic material and relatively flush with said first surface such that said overhang portion magnetically adheres to said frame surface for sealing cracks between said door and said frame.

5. The assembly as recited in claim 1 wherein said frame includes a frame surface comprising a magnetic material such that said strip magnetically adheres to said frame surface and said overhang portion extends beyond said frame.

6. The assembly as recited in claim 5 wherein said door includes a first surface relatively flush with said frame surface such that said overhang portion lies against said first surface for sealing cracks between said door and said frame.

7. The assembly as recited in claim 5 wherein said door includes a first surface comprising a magnetic material and relatively flush with said frame surface such that said overhang portion magnetically adheres to said first surface for sealing cracks between said door and said frame.

8. The assembly as recited in claim 1 wherein said strip comprises vinyl coated magnetic sheeting.

9. A method of using a weatherproofing assembly for sealing cracks between a door and an associated frame, said method comprising the step of:
(a) magnetically attaching at least one magnetic strip to at least one of a door and a frame such that an overhang portion of said strip extends beyond said at least one of said door and said frame.

10. The method as recited in claim 9 wherein said door comprises a magnetic material and wherein step (a) is further defined by attaching said strip to said door.

11. The method as recited in claim 10 wherein step (a) is further defined by attaching said strip parallel to said door such that said overhang portion extends beyond said door to lie against said frame when said door is in a closed position.

12. The method as recited in claim 11 further comprising the steps of:
(b) moving said door from a closed position to an open position, thereby moving said strip away from said frame; and
(c) returning said door to a closed position such that said strip lies against said frame for sealing cracks between said door and said frame.

13. The method as recited in claim 11 wherein said frame comprises a magnetic material, and wherein step (a) is further defined by magnetically attaching said strip to said frame.

14. The method as recited in claim 13 further comprising the step of:
(b) moving said door from a closed position to an open position, thereby moving said strip away from said frame and such that said strip detaches from said frame while remaining attached to said door;
(c) returning said door to a closed position; and
(d) magnetically reattaching said overhang portion to said frame for sealing cracks between said door and said frame.

15. The method as recited in claim 9 wherein said frame comprises a magnetic material and wherein step (a) is further defined by attaching said strip to said frame.

16. The method as recited in claim 15 wherein said frame includes a frame surface relatively flush with said door, and wherein step (a) is further defined by attaching said strip parallel to said frame surface such that said overhang portion extends beyond said frame to lie against said door when said door is in a closed position.

17. The method as recited in claim 16 further comprising the steps of:
(b) moving said door from a closed position to an open position, thereby moving said door away from said strip; and
(c) returning said door to a closed position such that said strip lies against said door for sealing cracks between said door and said frame.

18. The method as recited in claim 16 wherein said door comprises a magnetic material, and wherein step (a) is further defined by magnetically attaching said strip to said door.

19. The method as recited in claim 18 further comprising the step of:
(b) moving said door from a closed position to an open position, thereby moving said door away from said strip such that said strip detaches from said door while remaining attached to said frame;
(c) returning said door to a closed position; and
(d) magnetically reattaching said overhang portion to said frame.
